(19) United States
(12) Patent Application Publication
(10) Pub. No.: US 2012/0036105 A1
(43) Pub. Date: Feb. 9, 2012

(54) Method and Apparatus for Distributing Data in a Peer-To-Peer Network

(76) Inventors: Victor Souza, Solna (SE); Kent Bogestam, Hagersten (SE); Ayodele Damola, Solna (SE)

(21) Appl. No.: 13/146,638

(22) PCT Filed: Feb. 17, 2009
(86) PCT No.: PCT/EP09/51860

§ 371 Date: Oct. 19, 2011

(51) Int. Cl. G06F 17/30; G06F 15/16

(52) U.S. Cl. 707/622; 709/206; 707/E17.01

(57) ABSTRACT

According to a first aspect of the present invention there is provided a method of distributing data to peers of a peer-to-peer network to enable those peers to provide data to other peers. The method comprises predefining a minimum number of peers that are required to store a data item, sending the data item to a number of data receiving peers from one or more data servers, determining if the number of data receiving peers that have sufficient storage capacity available to store the data item is less than the predefined minimum number, and, if it is, deleting previously stored data to make sufficient storage capacity available.

### TECHNICAL FIELD

The present invention relates to a method and apparatus for distributing data, and in particular to a method and apparatus for controlling the distribution of data.

### BACKGROUND

Video on demand (VoD) services allow users to select and view video content as and when they choose. VoD systems either stream content, for viewing in real-time, or download content, for viewing at any time, to a device such as a set-top-box (STB), digital video recorder, personal video recorder, portable media player, computer, mobile phone or PDA providing a VoD client. Download and streaming of video on demand allows user to view video content at their convenience but also provides users with functionality traditionally only available when replaying a transmission that was previously recorded using a VCR, DVD recorder or DVR (i.e. pausing, fast forwarding, and rewinding).

VoD content can be distributed to users from some central servers referred to as head end systems. VoD services usually rely on unicast mechanisms (e.g. HTTP) to distribute content as, whilst multicast is very efficient for distributing content to a number of users, multicast distribution does not support user on demand interaction. However, when distributing a large quantity of content to a large number of users simultaneously, these unicast distribution mechanisms are inefficient and therefore can be problematic for the head end systems that have limited CPU power and storage capacity.

In order to overcome these problems, peer-to-peer (P2P) mechanisms can be used to distribute VoD content. In a P2P system, the greater the number of peers in the network, the greater the storage capacity and CPU power there is available. As such, P2P mechanisms can be very efficient once there are a sufficient number of peers in the network. In a P2P VoD system content is either ‘pulled’ or ‘pushed’ from the head end VoD servers to the VoD client devices of a number of users. These VoD clients can then be accessed by other peer VoD client devices to obtain the desired video content.

When employing the pull mechanism, VoD content is captured by those VoD clients accessing the content “live”, during its initial transmission from the head end. These VoD clients can then be accessed and used as a source by other VoD clients as and when this content is viewed by other users, thereby enabling a time shift service. FIG. 1 illustrates schematically an example of a P2P VoD system in which content is pulled from the head end by the peers. The steps performed are as follows:
A1. A number of VoD clients 1 each independently choose to join a “live” stream of content from the service providers VoD server 2. For example, this may correspond to the scenario in which a viewer chooses to watch a TV program as it is transmitted.
A2. These VoD clients 1 join a multicast group and start receiving the desired content from the VoD server 2. The VoD server 2 can distribute pre-recorded content such as a movie, and stream live content such as a live sports event.
A3. As the content is received, each VoD client 1 stores it in its memory. When a VOD client 1 successfully stores content, it reports this to a tracker 3. The tracker 3 is a functional block which tracks what content is stored where. This tracker 3 can be either a centralized in the head end systems, located separately from the head end systems or may be a distributed system e.g. based on DHT.
A4. At some subsequent time another VoD client 4 requests this content. The tracker 3 responds to such a request with a reference to the VoD client or to a set of VoD clients that are currently online and possess the content, and are therefore able to act as a source of the requested content.
A5. The content is downloaded in a P2P manner from the source VoD client(s) 1 by the requesting VoD client 4. The user of the requesting VoD client 4 is then able to watch the content in a time shifted manner.

The push mechanism allows the VoD servers at the head end to distribute content to VoD clients even when the client has not requested that content. The assumption here is that the storage devices are constantly listening to one or more multicast groups such that they receive any content pushed to these groups by the VoD servers at the head end. FIG. 2 illustrates schematically an example of a P2P VoD system in which content is pushed from the head end to the VoD clients. The steps performed are as follows:
B1. The VoD server 2 prepares content to be stored across multiple VoD clients 1. The content may be split into ‘blocks’ suitable to be transmitted and stored between a number of VoD clients. The logic in the head end systems then selects one or more VoD clients 1 that are to store this content. The selected VoD clients 1 must be online.
B2. A multicast stream is then initiated to the selected VoD clients 1, with each of the selected VoD clients 1 being made to join the stream by means of some signalling protocol. Example of multicast protocols that can be used for this content distribution are File Delivery over Unidirectional Transport (FLUTE) (see RFC 3926) or Real-time Transport Protocol (RTP) (see RFC 3550)
B3. Each VoD client 1 that successfully receives and stores the content reports this to the tracker 3. This report includes an indication of the VoD client's ID (e.g. IP address) and the content it has ingested.
B4. At some subsequent time another VoD client 4 requests this content. The tracker 3 responds to such a request with a reference to the VoD client or to a set of VoD clients (e.g. their IP addresses) that are currently online and possess the content, and are therefore able to act as a source of the requested content.
B5. The requesting VoD client 4 starts a P2P session with the source VoD clients(s) 1. The required set of content blocks are retrieved, reassembled and rendered by the requesting VoD client 4. The user of the requesting VoD client 4 is then able to watch the content in a time shifted manner.

### SUMMARY

According to a first aspect of the present invention there is provided a method of distributing data to peers of a peer-to-peer network to enable those peers to provide data to other peers. The method comprises predefining a minimum number of peers that are required to store a data item, sending the data item to a number of data receiving peers from one or more data servers, determining if the number of data receiving peers that have sufficient storage capacity available to store the data item is less than the predefined minimum number, and, if it is, deleting previously stored data to make sufficient storage capacity available.

The step of determining if the number of data receiving peers that have sufficient storage capacity available to store the data item is less than the predefined minimum number may comprise, at each data receiving peer, if sufficient storage capacity is available, storing the data item and reporting storage of the data item to a tracker and, at the tracker, maintaining a record of the data stored at the peers and determining if the data item is stored at the predefined minimum number of peers.

The step of deleting previously stored data to make sufficient storage capacity available may comprise, at the tracker, using the record of the data stored at the peers to identify those data receiving peers that do not store the data item and to identify previously stored data that can be deleted from those data receiving peers, and sending instructions to those data receiving peers that do not store the data item to delete the identified previously stored data. At those data receiving peers that do not store the data item, upon receipt of instructions from the tracker, deleting the identified previously stored data.

The method may further comprise, at those data receiving peers that do not store the data item, following deletion of the previously stored data reporting the deletion of the previously stored data to the tracker. At the tracker, receiving reports that the previously stored data has been deleted, updating the record of the data stored at the peers, and sending instructions to the data servers to resend the data item to those data receiving peers that do not store the data item. At the data servers, resending the data item to those data receiving peers that do not store the data item.

Alternatively the step of determining if the number of data receiving peers that have sufficient storage capacity available to store the data item is less than the predefined minimum number may comprise, at the data servers, including metadata with the data item sent to the data receiving peers, the metadata at least indicating to the peers whether or not they must store the data item. At the data receiving peers, evaluating the metadata to determine if it is required that the data item be stored at that peer and, if it is, then determining if sufficient storage capacity is available.

The step of deleting previously stored data to make sufficient storage capacity available may then comprise, at the data receiving peers that do not have sufficient capacity available, selecting previously stored data that may be deleted, and deleting the selected data.

The step of deleting previously stored data to make sufficient storage capacity available may then comprise, at the data receiving peers, selecting previously stored data, sending a message to a tracker requesting permission to delete the selected data and receiving a response from the tracker granting or refusing permission.

If the response from the tracker refuses permission, at the data receiving peers, selecting alternative previously stored data that may be deleted, and requesting permission from the tracker to delete the alternative previously stored data and receiving a response from the tracker granting or refusing permission. If the response from the tracker grants permission, at the data receiving peers, deleting the selected data.

Alternatively, if the response from the tracker refuses permission, at the data receiving peers determining if the response identifies alternative previously stored data that can be deleted. If the response from the tracker does not identify alternative previously stored data, selecting alternative previously stored data that may be deleted, and requesting permission from the tracker to delete the alternative previously stored data. If the response from the tracker does identify alternative previously stored data, deleting the alternative previously stored data.

The method may further comprise, at the data receiving peers that have deleted previously stored data, storing the data item, and reporting deletion of the previously stored data and storage of the data item to a tracker.

According to a second aspect of the present invention there is provided a method of operating a peer in a peer-to-peer network. The method comprises receiving a data item from one or more data servers, determining if sufficient storage capacity is available to store the data item. If sufficient storage capacity is available, storing the data item and reporting storage of the data item to a tracker, and, if sufficient storage capacity is not available, and upon receipt of instructions from the tracker, deleting previously stored data. The method may further comprise, following deletion of previously stored data, reporting deletion of previously stored data to the tracker, receiving the data item from the one or more data servers, storing the data item and reporting storage of the data item to the tracker.

According to a third aspect of the present invention there is provided a method of operating a tracker in a peer-to-peer network. The method comprises receiving, from peers, reports of data items stored by those peers, maintaining a record of the data stored by the peers, determining if a data item is stored at a predefined minimum number of peers, and, if it is not, identifying those peers that do not store the data item, identifying previously stored data that can be deleted from those peers that do not store the data item, and instructing one or more peers that do not store the data item to delete the selected data. The method may further comprise, upon receipt of confirmation of deletion of the previously stored data, updating the record of the data stored at the peers, instructing one or more data distribution servers to resend the data item to those peers.

According to a fourth aspect of the present invention there is provided a method of operating a data server in a peer-to-peer network. The method comprises sending a data item to one or more peers, the data item including metadata, the metadata at least indicating to the peers whether or not they must store the data item.

According to a fifth aspect of the present invention there is provided a method of operating a peer in a peer-to-peer network. The method comprises receiving a data item from one or more data servers, the data including metadata, evaluating the metadata to determine if it is required that the new item be stored at the peer, and, if it is, determining if sufficient storage capacity is available to store the data item.

If sufficient storage capacity is available to store the data item, storing the data item and reporting storage of the data item to a tracker. If sufficient storage capacity is not available to store the date item, selecting previously stored data that may be deleted, and deleting the selected data. Alternatively, if sufficient storage capacity is not available to store the data item, selecting previously stored data that may be deleted, sending a message to a tracker requesting permission to delete the selected data and receiving a response from the tracker.

If the response from the tracker grants permission, deleting the previously stored data, storing the data item and reporting storage of the data item to the tracker. If the response from the tracker refuses permission, determining if the response identifies alternative previously stored data that can be deleted. If the response from the tracker does identify alternative previously stored data, deleting the alternative previously stored data, storing the data item and reporting storage of the data item to the tracker. If the response from the tracker does not identify alternative previously stored data, selecting alternative previously stored data that may be deleted, and sending a message to the tracker requesting permission to delete the alternative previously stored data.

The method may further comprise, following the deletion of previously stored data, storing the data item and reporting deletion of the previously stored data and storage of the data item to the tracker.

According to a sixth aspect of the present invention there is provided a method of operating a tracker in a peer-to-peer network. The method comprises receiving, from peers, reports of data stored by the peers, maintaining a record of the data stored by the peers, receiving, from peers, requests for permission to delete some selected data, determining if the selected data can be deleted using the record of stored data, and sending a response to the requesting peers indicating if permission to delete the selected data is granted or refused. If it is determined that the selected data can not be deleted, using the record of stored data to identify alternative data that can be deleted, and sending a response to the requesting peers indicating that permission to delete the selected data is refused and identifying the alternative data.

The data may comprise video and the peers may comprise clients in a Video on Demand system.

According to a seventh aspect of the present invention there is provide an apparatus configured to operate as a peer in a peer-to-peer network. The apparatus comprises a memory unit for storing data, a receiver for receiving a data item from data servers, a transmitter for sending messages to a tracker, a receiver for receiving messages from a tracker, and a processor unit. The processor unit is for determining if sufficient memory is available to store a data item, if sufficient memory is available, implementing storage of the data item and generating a message reporting successful storage of the data item to a tracker, if sufficient memory is not available and upon receipt of a message containing instructions from a tracker, implementing deletion of previously stored data in accordance with the instructions, and generating messages reporting deletion of previously stored data to the tracker.

According to an eighth aspect of the present invention there is provide an apparatus configured to operate as a tracker in a peer-to-peer network. The apparatus comprises a receiver for receiving messages from peers, a transmitter for sending messages to peers, a transmitter for sending messages to data servers, a memory unit for maintaining a record of data stored by the peers, and a processor unit. The processor unit is for determining if the tracker has received a predefined minimum number of messages from peers reporting storage of a data item, if not, selecting previously stored data that may be deleted, generating messages instructing one or more of the peers that do not store the data item to delete the previously stored data and, upon receipt of confirmation of deletion of the previously stored data, generating messages instructing one or more data servers to resend the data item to those peers that have confirmed deletion of the previously stored data.

According to a ninth aspect of the present invention there is provide an apparatus configured to operate as a data server in a peer-to-peer network. The apparatus comprises a memory unit for storing data, a processor unit for generating metadata for inclusion with a data item, the metadata at least indicating to peers whether or not they must store the data item, and a transmitter for sending the data item to one or more peers, the data item including the metadata.

According to a tenth aspect of the present invention there is provide an apparatus configured to operate as a peer in a peer-to-peer network. The apparatus comprises a memory unit for storing data, a receiver for receiving a data item from one or more data servers, the data including metadata, and a processor unit for evaluating the metadata to determine if it is required that the data item be stored at the peer. If it is intended that the data item be stored, the processor unit determines if sufficient storage capacity is available to store the data item.

If sufficient storage capacity is available, the processor unit may implement storage of the data item and generate messages reporting storage of the data item to a tracker. If sufficient memory is not available, the processor unit may select previously stored data that may be deleted, implement deletion of the previously stored data, implement storage of the data item and generate messages reporting deletion of the previously stored data and storage of the data item to the tracker. The apparatus may further comprise a transmitter for sending messages to the tracker.

Alternatively, if sufficient memory is not available, the processor unit may select previously stored data that may be deleted, and generate messages to a tracker requesting permission to delete the previously stored data. The apparatus may further comprise a transmitter for sending messages to a tracker, and a receiver for receiving messages from the tracker.

If the response from the tracker grants permission, the processor unit may implement deletion of the previously stored data, implement storage of the data item and generate messages reporting deletion of the previously stored data and storage of the data item to the tracker. If the response from the tracker does not grant permission, the processor unit may determine if the response identifies alternative previously stored data that can be deleted. If the response from the tracker does identify alternative previously stored data, the processor unit may implement deletion of the alternative previously stored data, implement storage of the data item and generate messages reporting deletion of the alternative previously stored data and storage of the data item to the tracker. If the response from the tracker does not identify alternative previously stored data, the processor unit may select alternative previously stored data that may be deleted, and generate a message to the tracker requesting permission to delete the alternative previously stored data.

According to an eleventh aspect of the present invention there is provided an apparatus configured to operate as a tracker in a peer-to-peer network. The apparatus comprises a receiver for receiving messages from peers, a transmitter for sending messages to peers, a transmitter for sending messages to data servers, a memory unit for maintaining a record of data stored by the peers, and a processor unit for, upon receipt of a request for permission to delete some previously stored data from a peer, using the record of stored data to determine if the previously stored data can be deleted, and generating a message to the requesting peers indicating if permission to delete the selected data is granted or refused.

If it is determined that the previously stored data can not be deleted, the processor unit may use the record of stored data to identify alternative previously stored data that can be deleted, and generate a message to the requesting peer indicating that permission to delete the previously stored data is refused and identifying the alternative previously stored data.

The data may comprise video and the peers may comprise clients in a Video on Demand system.

### BRIEF DESCRIPTION OF THE DRAWINGS

FIG. 1 illustrates schematically an example of a P2P VoD system in which content is pulled from the head end by the peers;

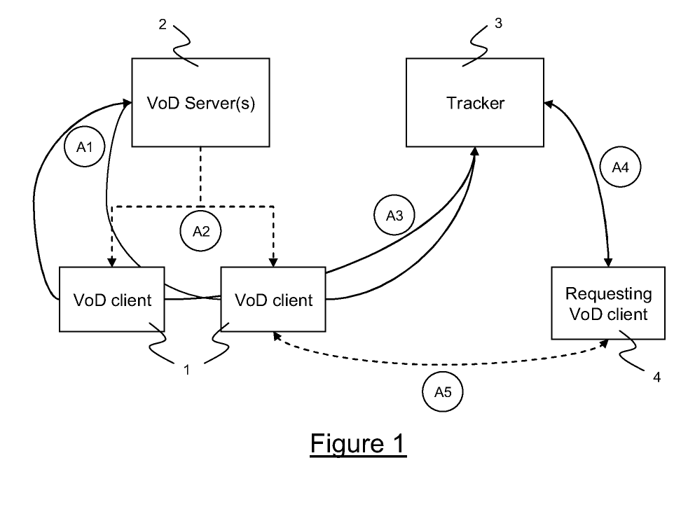

FIG. 2 illustrates schematically an example of a P2P VoD system in which content is pushed from the head end to the peers;

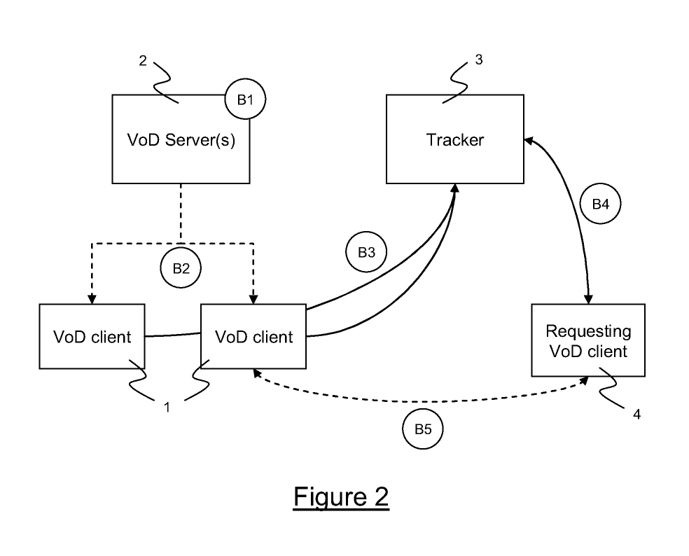

FIG. 3 is a flow diagram illustrating an example of the data storage control method according to an embodiment of the present invention;

FIG. 4 illustrates a simplified example signalling flow of the control of a content storage by an active tracker according to an embodiment of the present invention;

FIG. 5 is a flow diagram illustrating an example of the process implemented by an active tracker according to an embodiment of the present invention;

FIG. 6 illustrates a simplified example signalling flow of a VoD client controlling its content storage according to an embodiment of the present invention;

FIG. 7 is a flow diagram illustrating an example of the process implemented by a VoD client according to an embodiment of the present invention;

FIG. 8 illustrates a simplified example signalling flow of a VoD client collaborating with an active tracker according to an embodiment of the present invention;

FIG. 9 is a flow diagram illustrating an example of the process implemented by the VoD client collaborating with an active tracker according to an embodiment of the present invention; and

FIG. 10 illustrates schematically an example of a VoD system according to an embodiment of the present invention.

### DETAILED DESCRIPTION

It is recognised here that the problem with existing peer-to-peer technology is that it does not ensure that a specific item of data is stored by those peers selected by the centralised systems. With regards to the Video on Demand systems described above, the tracker functionality merely keeps track of which peers hold which items of data. For example, any of the selected peers may have insufficient storage capacity available to store any further data. This could lead to a situation in which the number of peers successfully storing the data is insufficient to adequately service the P2P network. In order to overcome this problem it is proposed here to introduce data storage control which ensures that data is stored by a sufficient number of peers, as required by operator policy.

There will now be described a method by which the storage of data at the peers can be controlled. The method involves predefining a minimum number of peers that are required to store an item of data, sending the data item to a number of peers, and then determining the number of peers to which that data has been sent and that also have sufficient storage capacity available to store the data item. If it is then determined that this number is less than the predefined minimum number, previously stored data is deleted in order to make sufficient storage capacity available to store the data item at at least the predefined minimum number of peers.

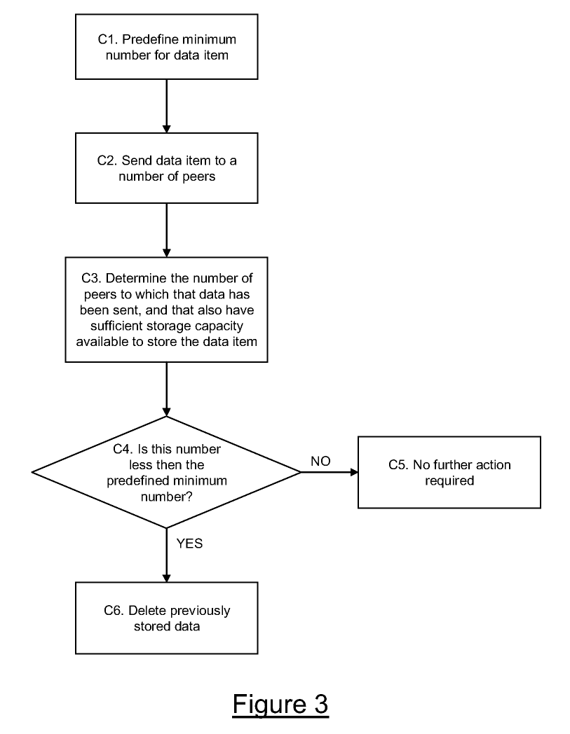

FIG. 3 is a flow diagram illustrating an example of the data storage control method. The steps performed are as follows:
C1. The centralised systems belonging to the operator of the data distribution service contain some logic or policy by which they can determine the minimum number of peers that are required to store an item of data that is to be distributed.
C2. This item of data is then sent from the data servers of the data distribution service to a number of peers. This number of peers must be at least the predefined minimum number of peers.
C3. The number of peers to which that data has been sent, and that also have sufficient storage capacity available to store the data item is determined.
C4. It is then determined if this number is less then the predefined minimum number.
C5. If it is determined not to be less than the predefined minimum number, i.e. the number of peers is equal to or more than the minimum number, then no further action is taken.
C6. If it is determined to be less than the predefined minimum, previously stored data is deleted from a number of peers in order to make sufficient storage capacity available to store the data item at at least the predefined minimum number of peers.

This method of data storage control may be achieved in a number of ways. For example, one possible solution involves introducing an active tracker to explicitly instruct the peers to store data once they have reported that the data has been received from one or more data distribution servers. The active tracker is responsible for enforcing the storage requirements set by the operator of the data distribution systems.

When making use of an active tracker the operator of the peer-to-peer data distribution system will be able to enforce a set of policies specifying what data must be found in the system. For example, in a Video on Demand system these policies could specify that 10,000 movies must always be available to an end user of the system, or that TV content which has been transmitted in the last 3 weeks must be available to an end user. Furthermore, the operator of a VoD system will require that a minimum number of VoD clients store the content (e.g. a desired replication factor), in order to ensure that there are a sufficient number of sources to provide this content to other VoD clients in the P2P network. As such, if the number of messages from peers reporting storage of a data item received by the active tracker does not meet this requirement the active tracker will then ‘force’ certain VoD clients to store the content, by instructing them to delete other content to free sufficient memory. This could be achieved by the active tracker making use of its knowledge of the content stored at each VoD client to select appropriate content for deletion, and instructing the VoD clients accordingly. These VoD clients would then delete sufficient content and store the new content when re-transmitted from the head end VoD servers.

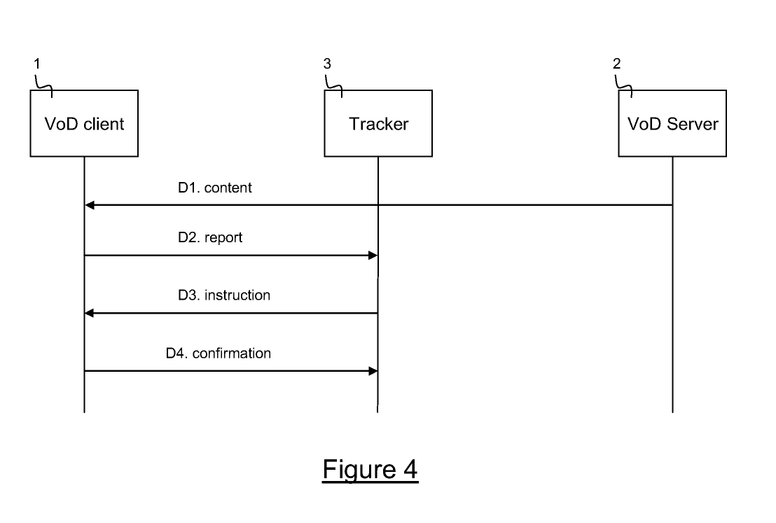

FIG. 4 illustrates a simplified example signalling flow of the control of a content storage by an active tracker in a VoD system. The steps performed are as follows:
D1. The VoD client 1 receives content from the head end VoD servers 2 via a multicast push/pull event. The VoD server 2 can distribute pre-recorded content such as a movie, and stream live content such as a live sports event. The received content is stored in the VoD client 1.
D2. The VoD client 1 then sends a report to the active tracker 5 specifying the content it has received and stored. The active tracker 5 uses the reports received from the VoD clients to build a complete picture of the content distributed and stored at the VoD clients. This information is then used to manage content across all VoD clients.
D3. If the number of reports is less than is required, this number being defined by the operator of the service, the active tracker 5 will take any action that is required to rectify the problem, and then ensure that another attempt is made to store content in the VoD clients. For example, the active tracker 5 may instruct a number of VoD clients to delete some content to free up space prior to the system making another attempt to store the content at those clients. Optionally, the active tracker 5 can also determine how to further manage the content stored at each VoD client. For example, the active tracker can send an instruction to the client to delete content, to set the expiry date of the content, after which it is to be deleted, or to move the content to another client.
D4. The VoD client 1 then acknowledges the receipt of any instruction(s) from the active tracker 5. In addition, the client can also report back the result of an operation resulting from these instructions.

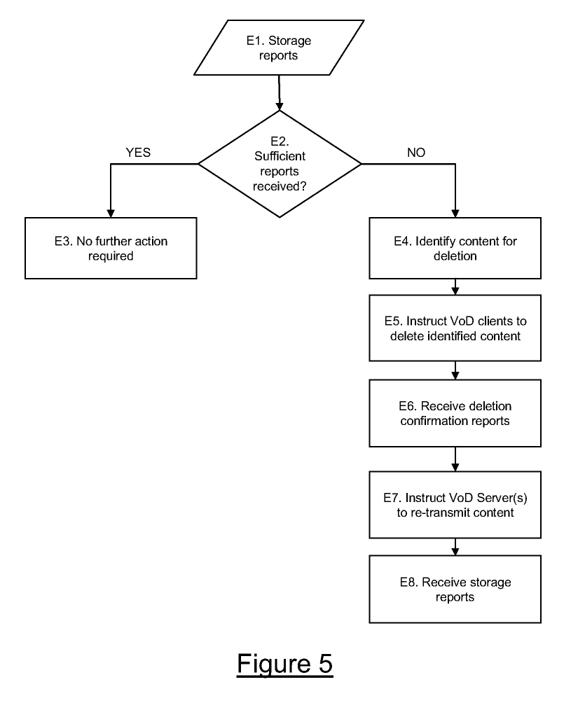

FIG. 5 is a flow diagram illustrating an example of the process implemented by an active tracker in a VoD system. The steps performed are as follows:
E1. The active tracker 5 receives a number of reports relating to an item of content distributed by the head end VoD servers 2.
E2. Once the head end VoD servers 2 have completed distributing the content, the active tracker 5 determines the whether or not the number of successful storage reports received from VoD clients 1 meets the requirements set by the VoD service operator (i.e. minimum number/replication factor).
E3. If the active tracker 5 determines that a sufficient number of successful storage reports have been received, the active tracker 5 takes no further action.
E4. If the active tracker 5 determines that an insufficient number of successful storage reports have been received, the active tracker uses its knowledge of the content stored by the clients forming the P2P network to identify content that can be deleted from VoD clients to enable sufficient storage.
E5. The active tracker 5 then instructs the appropriate VoD clients to delete the selected content.
E6. The active tracker 5 then receives confirmation reports from the VoD clients, confirming successful deletion of content, as instructed.
E7. The active tracker 5 then instructs the head end VoD servers 2 to re-transmit the content to the relevant VoD clients.
E8. The active tracker 5 then receives successful storage reports from the instructed VoD clients once they have stored the re-transmitted content.

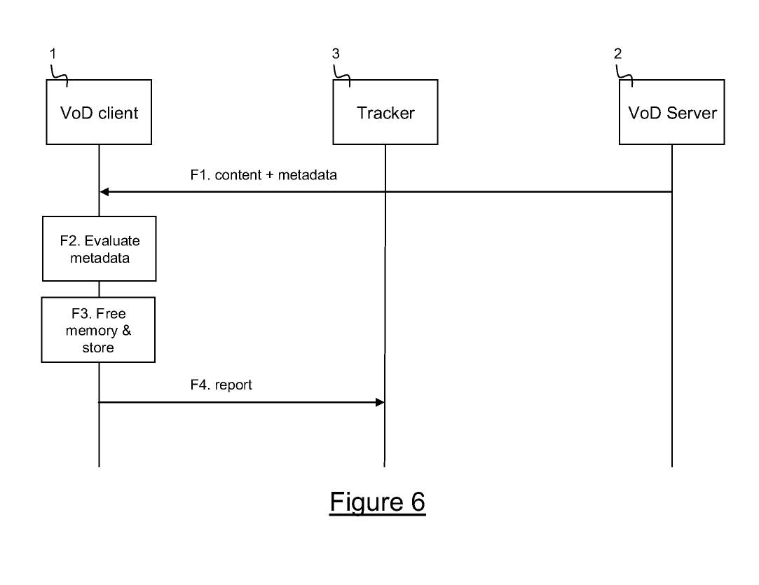

As an alternative solution to the problems outlined above, content storage control can be performed by the VoD client itself, with the VoD client actively implementing storage instructions that are received from the head end VoD servers 2 when the content is initially distributed into the P2P network. FIG. 6 illustrates a simplified example signalling flow of a VoD client controlling its content storage. The steps performed are as follows:
F1. The VoD client 1 receives content from the head end VoD servers 2 via a multicast push/pull event. The head end VoD servers 2 also include some metadata with the content, this metadata indicating which clients should store the content. The received metadata can also indicate other requirements, such as whether content should be stored in temporary or permanent storage segments of the client device, the duration of storage or some content priority etc.
F2. The VoD client 1 evaluates this metadata and determines that the content is intended to be stored by the client. For example, each VoD client may be a member of a group of VoD clients, with each group responsible for storing a particular set of content. As such, each VoD client in a group may be provided with a set of rules that the client should use to determine which content it should store, in order to conform to the requirements of the group. The VoD client may then evaluate the metadata according to these rules to determine if it should store this content. This grouping of VoD clients, wherein the clients in a group only store content that conforms to the requirements of the group, provides a mechanism for controlling the replication of content across the clients forming the P2P network.
F3. If the VoD client 1 is intended to store this content, but does not have sufficient memory, the VoD client 1 decides which of the previously stored content should be deleted. This decision can be made using some logic programmed into the VoD client, possibly taking into account information provided in the metadata of the previously stored content. The VoD client 1 then deletes the identified content and stores the newly received content.
F4. The VoD client 1 then sends a report to a tracker 3 indicating that the client now has a piece of content, together with any other relevant information such as the duration of time that the content will be stored by the client. If any previously stored content has been deleted, the VoD client 1 also reports details of this to the tracker.

Alternatively, a VoD client may attempt to store all content received from the VoD servers unless it does not have sufficient memory, in which case it will then determine if it needs to store the content and, if so, which of the previously stored content it can delete.

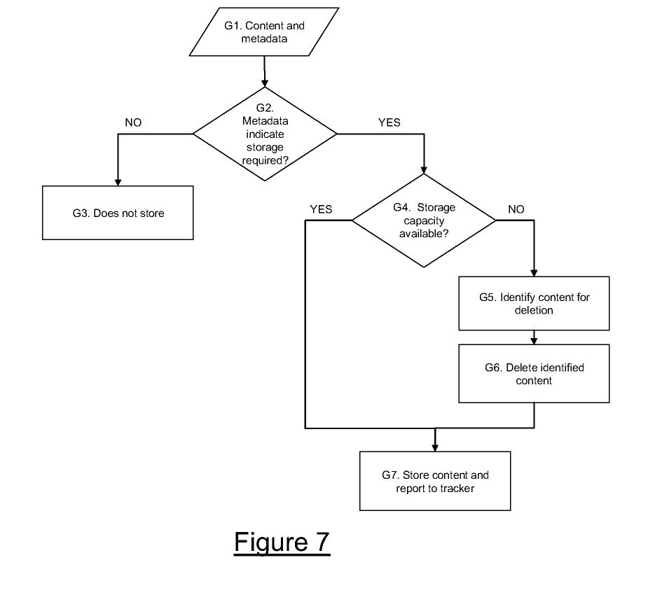

FIG. 7 is a flow diagram illustrating an example of the process implemented by the VoD client when actively implementing storage instructions received with an item of content. The steps performed are as follows:
G1. The VoD client 1 receives some content and associated metadata.
G2. The VoD client 1 then determines whether or not the metadata indicates that this content should be stored. This may involve evaluating the metadata according to the VoD clients set of rules.
G3. If it is determined that storage of this content is not required then the VoD client 1 continues with any necessary processing but does not store the content.
G4. If it is determined that storage of this content is required then the VoD client 1 determines whether or not it has sufficient storage capacity available. If the VoD client 1 does have sufficient storage capacity the process proceeds to step G7.
G5. If the VoD client 1 does not have sufficient storage capacity available then it identifies which of the previously stored content should be deleted in order to free sufficient storage capacity.
G6. The VoD client 1 then deletes the identified content.
G7. If sufficient storage capacity is available, or once sufficient storage capacity has been made available, the VoD client 1 stores the content and reports successful storage to the tracker 3. The VoD client 1 also reports details of any deleted content to the tracker 3.

Once again, as an alternative to this process, a VoD client may attempt to store all content received from the VoD servers unless it does not have sufficient memory, in which case it will then determine if it needs to store the content and, if so, what of the previously stored content it can delete.

The inclusion of metadata with the content makes it possible for the head end VoD servers to indicate to particular VoD clients whether of not the content they receive must be stored. In a typical scenario, this could be implemented by including a priority flag in the content metadata. If content with an enabled priority flag is received by a VoD client, the VoD client must then endeavour to store this content, for example, by deleting existing content if the current storage capacity of the client is full. The decision as to which items of previously stored content should be deleted would be made by the VoD client based on some programmed logic, possibly in combination with other information provided in metadata received with the previously stored content.

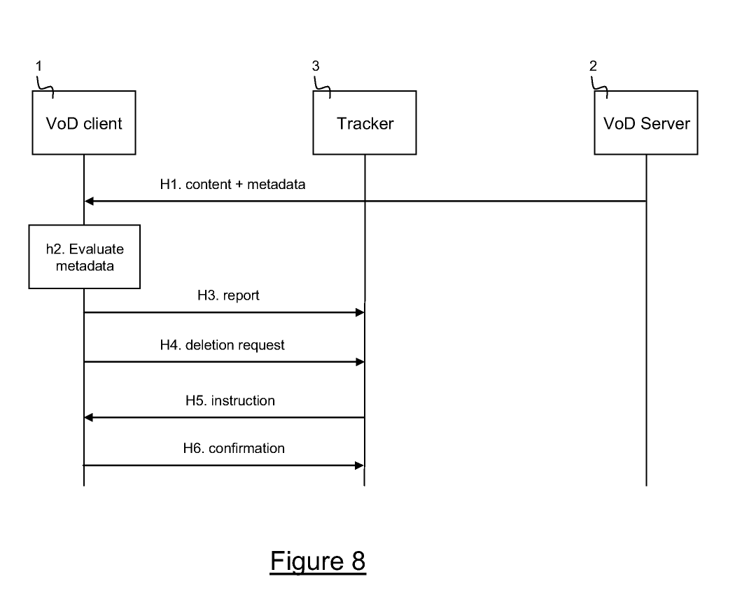

As a third alternative solution to the problem, content storage at the VoD client can be controlled by collaboration between the client and an active tracker. FIG. 8 illustrates a simplified example signalling flow of a VoD client collaborating with the tracker to control content storage. The steps performed are as follows:
H1. The VoD client 1 receives content from the head end VoD servers 2 via a multicast push/pull event. The head end VoD servers 2 also include some metadata with the content, this metadata indicating which clients should store the content. The received metadata can also indicate other requirements, such as whether content should be stored in temporary or permanent storage segments of the client device, the duration of storage or some content priority etc.
H2. The VoD client 1 determines whether the content is intended to be stored by the client. This may involve evaluating the metadata according to the VoD clients set of rules.
H3. The VoD client 1 reports receipt of content to the active tracker 5.
H4. If it is determined that the VoD client 1 is required to store the content, but the VoD client 1 needs to free up some storage space in order to do so, the logic or rules of the client could select a specific item of previously stored content to be deleted. In this case, the VoD client 1 then sends a message to the active tracker 5 requesting permission to delete the selected content.
H5. Depending on the operator's storage requirements and the availability of the content selected by the VoD client 1 across all other clients, the active tracker 5 determines whether or not to allow the client to remove the selected content and instructs the client accordingly. If the active tracker 5 determines that the VoD client 1 should not delete the selected content it can make use of its knowledge of the content already stored at the client to determine which content can be deleted. In this case, these instructions are also returned to the VoD client 1.
H6. The client acknowledges the active tracker's 5 instructions. If the active tracker 5 denies permission for the client to delete the selected content, and does not provide any instruction as to which content can be deleted, the VoD client 1 selects an alternative item of content and sends a further message to the active tracker 5 requesting permission to delete this alternative content. This process can continue until the client is permitted to delete sufficient content.

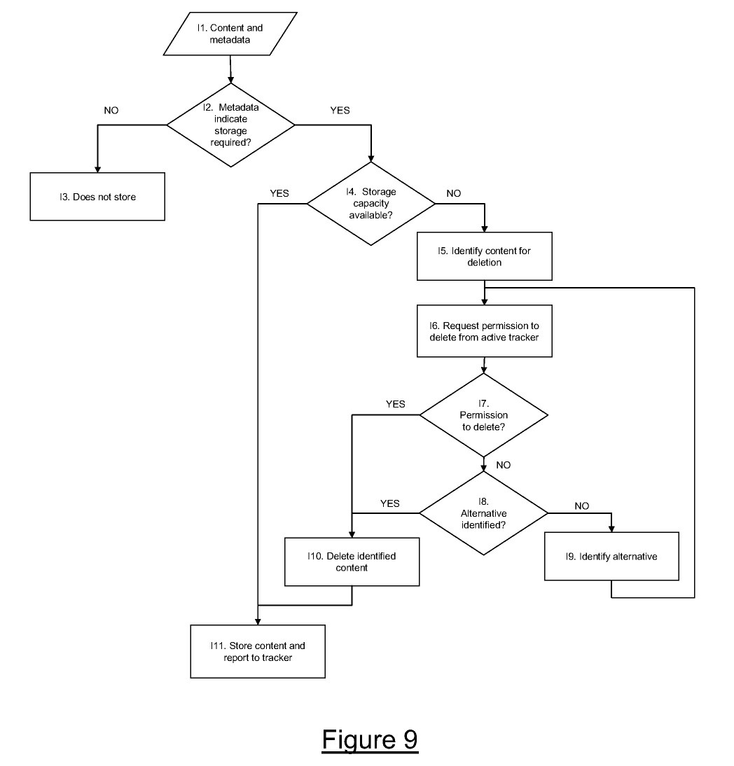

FIG. 9 is a flow diagram illustrating an example of the process implemented by the VoD client when actively implementing storage instructions received with an item of content, in collaboration with an active tracker. The steps performed are as follows:
I1. The VoD client 1 receives some content and associated metadata.
I2. The VoD client 1 then evaluates the metadata to determine whether or not it indicates that this content should be stored. This may involve evaluating the metadata according to the VoD clients set of rules.
I3. If it is determined that storage of this content is not required then the VoD client 1 continues with any necessary processing of the content but does not store the content.
I4. If it is determined that storage of this content is required then the VoD client 1 determines whether or not it has sufficient storage capacity available. If sufficient storage capacity is available the process proceeds to step I11.
I5. If the VoD client 1 does not have sufficient storage capacity available then it identifies which of the previously stored content could be deleted in order to free sufficient storage capacity.
I6. The VoD client 1 then sends a message to the active tracker 5 requesting permission to delete the identified content.
I7. The VoD client 1 then receives instructions from the active tracker 5 indicating whether or not the VoD client can delete the identified content. If the active tracker 5 does grant permission for the VoD client 1 to delete the identified content, the process proceeds to step I10.
I8. If the active tracker 5 does not grant permission for the VoD client 1 to delete the identified content, the VoD client 1 determines if the instructions from the active tracker 5 also identifies some alternative content for deletion.
I9. If the instructions from the active tracker 5 do not identify any alternative content for deletion, then the VoD client 1 identifies some alternative content and again requests permission from the active tracker 5 to delete this content. The process then returns to step I7.
I10. If the active tracker 5 grants permission to delete the content identified by the VoD client 1 or the instructions from the active tracker 5 do identify some alternative content for deletion, then the VoD client 1 deletes the identified content.
I11. If sufficient storage capacity is available, or once sufficient storage capacity has been made available, the VoD client 1 stores the content and report successful storage to the active tracker 5.

As an alternative to this process, a VoD client may attempt to store all content received from the VoD servers unless it does not have sufficient memory, in which case it will determine if it needs to store the content. If it does need to store the content it will then determine what of the previously stored content the tracker will allow it to delete.

As a further alternative, the metadata provided may not simply indicate that storage is required but may indicate a storage priority. In this case, some logic programmed into the VoD client then determines if the priority of this content requires that it be stored, at the expense of deleting content with a lower priority. In addition, the metadata may include a number of priorities, each with a duration or expiry date, such that the priority of an item of content may vary, for example, depending on the age of the content.

The methods described above provide the operator of a data distribution service with the ability to control the distribution of data throughout the P2P network formed by the clients, and thereby provide an effective service making use of P2P distribution mechanisms and the advantages they provide. Theses methods ensure that data is sufficiently available to meet both the operator's requirements and the demand for data made by users of the service, whilst also providing flexibility in the way that data storage can be controlled stored across a multitude of clients.

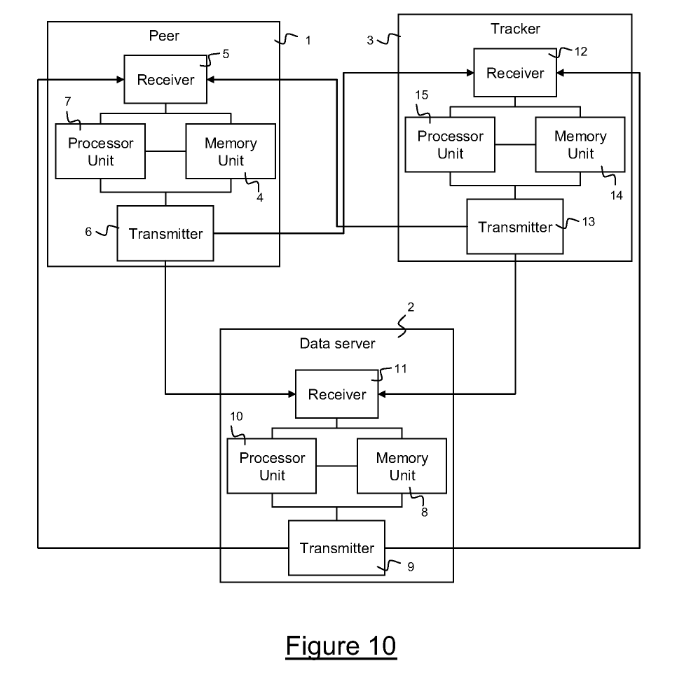

FIG. 10 illustrates schematically an example of a data distribution system in which the methods described above can be implemented. The system includes a number of peers/clients 1, one or more data servers 2 and one or more trackers 3.

The peer 1 is suitable for implementing the methods described above. The peer 1 can be implemented as a combination of computer hardware and software. The peer 1 comprises a memory unit 4 for storing data, a receiver 5 for receiving new data from one or more data servers and receiving messages from a tracker, a transmitter 6 for sending messages to a tracker, and a processor unit 7. The data received from the data servers may also include metadata. The processor unit 7 is suitable for implementing any or all of the solutions described above.

The processor unit 7 may determine if sufficient memory is available to store new data, and if sufficient memory is available, then implement storage of the new data and generate a message reporting successful storage of the new data to a tracker 3. If sufficient memory is not available and upon receipt of a message containing instructions from a tracker, the processor unit 7 may implement deletion of previously stored data in accordance with the instructions from the tracker 3, and generate a message reporting deletion of previously stored data to the tracker 3.

Alternatively, the processor unit 7 may also evaluate any metadata included with any received data, in order to determine if it is intended that this data is stored at the peer 1. Then, if it is intended that the new data be stored, the processor unit 7 may determine if sufficient memory is available to store the new data. If sufficient memory is available, the processor unit 7 may implement storage of the new data and generate a message reporting storage of the new data to a tracker 3.

If sufficient memory is not available, the processor unit 7 may select previously stored data that may be deleted, implement deletion of the selected data, implement storage of the new data and generate a message reporting storage of the new data to the tracker 3. Alternatively, if sufficient memory is not available, the processor unit 7 may select previously stored data that may be deleted, and generate a message to a tracker 3 requesting permission to delete the selected data.

Upon receipt of a response from the tracker 3, if the response from the tracker 3 grants permission, the processor unit 7 may implement deletion of the selected data, implement storage of the new data and generate a message reporting storage of the new data to the tracker 3. If the response from the tracker 3 does not grant permission, the processor unit 7 may determine if the response identifies alternative previously stored data that can be deleted.

If the response from the tracker 3 does identify alternative previously stored data, the processor unit 7 may implement deletion of the alternative previously stored data, implement storage of the new data and generate a message reporting storage of the new data to the tracker 3. If the response from the tracker 3 does not identify alternative previously stored data, the processor unit 7 may select alternative previously stored data that may be deleted, and generate a message to the tracker 3 requesting permission to delete the alternative previously stored data.

The data server 2 is suitable for implementing the methods described above. The data server 2 can be implemented as a combination of computer hardware and software. The data server 2 comprises a memory unit 8 for storing data and a transmitter 9 for sending data to one or more peers, the data including metadata. The data server 2 may also comprise a processor unit 10 for generating metadata for inclusion with data, the metadata being such that it can be evaluated by the peers to determine if it is intended that they store the data. The data server 2 may also comprise a receiver 11 for receiving instructions from a tracker 3.

The tracker 3 is suitable for implementing the methods described above. The tracker 3 can be implemented as a combination of computer hardware and software. The tracker 3 comprises a receiver 12 for receiving messages from peers, a transmitter 13 for sending messages to peers and sending messages to data servers, a memory unit 14 for maintaining a record of all content stored by the peers, and a processor unit 15. The processor unit 15 is suitable for implementing any or all of the solutions described above.

The processor unit 15 may determine if the tracker has received a minimum number of messages from peers 1 reporting successful storage of new data and, if not, select previously stored data that may be deleted from those peers not reporting successful storage, generate messages instructing the relevant peers to delete the selected data and, upon receipt of confirmation of deletion of the selected data, generate messages instructing one or more data servers to resend the new data to the relevant peers.

Alternatively, the processor unit 15 may, upon receipt of requests for permission to delete some selected data from peers 1, use the record of stored data to determine if selected data can be deleted, and generate messages to the requesting peers indicating if permission to delete the selected data is granted or refused. If it is determined that the selected data can not be deleted, the processor unit 15 may use the record of stored data to identify alternative data that can be deleted, and generate a message to the requesting peers indicating that permission to delete the selected data is refused and identifying the alternative data.

It will be appreciated by the person of skill in the art that various modifications may be made to the above-described embodiments without departing from the scope of the present invention. For example, whilst the invention has been described with regards to a Video on Demand service, it could equally be used for the distribution of any data. In addition, as previously described, the tracker functionality can be centralized in the head end systems, located separately or based on a distributed system such as DHT. Furthermore, as opposed to the use of a single tracker, a number of trackers may be used to implement the tracker functionality, forming a single logical tracker, and allowing the tracker functionality to be scaled proportionally to the network.

1. A method of distributing data to peers of a peer-to-peer network to enable those peers to provide data to other peers, the method comprising:
predefining a minimum number of peers that are required to store a data item;
sending the data item to a number of data receiving peers from one or more data servers;
determining if the number of data receiving peers that have sufficient storage capacity available to store the data item is less than the predefined minimum number; and
if it is, deleting previously stored data to make sufficient storage capacity available.

2. A method as claimed in claim 1, wherein the step of determining if the number of data receiving peers that have sufficient storage capacity available to store the data item is less than the predefined minimum number comprises:
at each data receiving peer, if sufficient storage capacity is available, storing the data item and reporting storage of the data item to a tracker; and
at the tracker, maintaining a record of the data stored at the peers, and determining if the data item is stored at the predefined minimum number of peers.

3. A method as claimed in claim 2, wherein the step of deleting previously stored data to make sufficient storage capacity available comprises:
at the tracker, using the record of the data stored at the peers to identify those data receiving peers that do not store the data item and to identify previously stored data that can be deleted from those data receiving peers, and sending instructions to those data receiving peers that do not store the data item to delete the identified previously stored data; and
at those data receiving peers that do not store the data item, upon receipt of instructions from the tracker, deleting the identified previously stored data.

4. A method as claimed in claim 3, and further comprising:
at those data receiving peers that do not store the data item, following deletion of the previously stored data, reporting the deletion of the previously stored data to the tracker;
at the tracker, receiving reports that the previously stored data has been deleted, updating the record of the data stored at the peers, and sending instructions to the data servers to resend the data item to those data receiving peers that do not store the data item; and
at the data servers, resending the data item to those data receiving peers that do not store the data item.

5. A method as claimed in claim 1, wherein the step of determining if the number of data receiving peers that have sufficient storage capacity available to store the data item is less than the predefined minimum number comprises:
at the data servers, including metadata with the data item sent to the data receiving peers, the metadata at least indicating to the peers whether or not they must store the data item; and
at the data receiving peers, evaluating the metadata to determine if it is required that the data item be stored at that peer and, if it is, then determining if sufficient storage capacity is available.

6. A method as claimed in claim 5, wherein the step of deleting previously stored data to make sufficient storage capacity available comprises:
at the data receiving peers that do not have sufficient capacity available, selecting previously stored data that may be deleted, and deleting the selected data.

7. A method as claimed in claim 5, wherein the step of deleting previously stored data to make sufficient storage capacity available comprises:
at the data receiving peers, selecting previously stored data, sending a message to a tracker requesting permission to delete the selected data and receiving a response from the tracker granting or refusing permission.

8. A method as claimed in claim 7, wherein if the response from the tracker refuses permission, then performing:
selecting alternative previously stored data that may be deleted, and requesting permission from the tracker to delete the alternative previously stored data and receiving a response from the tracker granting or refusing permission; and
if the response from the tracker grants permission, deleting the selected data.

9. A method as claimed in claim 7, wherein if the response from the tracker refuses permission, then performing:
determining if the response identifies alternative previously stored data that can be deleted;
if the response from the tracker does not identify alternative previously stored data, selecting alternative previously stored data that may be deleted, and requesting permission from the tracker to delete the alternative previously stored data; and
if the response from the tracker does identify alternative previously stored data, deleting the alternative previously stored data.

10. A method as claimed in claim 6, and further comprising:
at the data receiving peers that have deleted previously stored data, storing the data item, and reporting deletion of the previously stored data and storage of the data item to a tracker.

11. A method of operating a peer in a peer-to-peer network, the method comprising:
receiving a data item from one or more data servers;
determining if sufficient storage capacity is available to store the data item;
if sufficient storage capacity is available, storing the data item and reporting storage of the data item to a tracker; and
if sufficient storage capacity is not available, and upon receipt of instructions from the tracker, deleting previously stored data.

12. A method as claimed in claim 11, and further comprising:
following deletion of previously stored data, reporting deletion of previously stored data to the, tracker:
receiving the data item from the one or more data servers, servers:
storing the data item; and
reporting storage of the data item to the tracker.

13. A method of operating a tracker in a peer-to-peer network, the method comprising:
receiving, from peers, reports of data items stored by those peers;
maintaining a record of the data stored by the peers;
determining if a data item is stored at a predefined minimum number of peers; and
if it is not, identifying those peers that do not store the data item, identifying previously stored data that can be deleted from those peers that do not store the data item, and instructing one or more peers that do not store the data item to delete the selected data.

14. A method as claimed in claim 13, and further comprising:
upon receipt of confirmation of deletion of the previously stored data, updating the record of the data stored at the peers, instructing one or more data distribution servers to resend the data item to those peers.

15. A method of operating a data server in a peer-to-peer network, the method comprising:
sending a data item to one or more peers, the data item including metadata, the metadata at least indicating to the peers whether or not they must store the data item.

16. A method of operating a peer in a peer-to-peer network, the method comprising:
receiving a data item from one or more data servers, the data including metadata;
evaluating the metadata to determine if it is required that the new item be stored at the peer; and
if it is, determining if sufficient storage capacity is available to store the data item.

17. A method as claimed in claim 16, wherein if sufficient storage capacity is available to store the data item, storing the data item and reporting storage of the data item to a tracker.

18. A method as claimed in claim 16, wherein if sufficient storage capacity is not available to store the data item, selecting previously stored data that may be deleted, and deleting the selected data.

19. A method as claimed in claim 18, and further comprising:
following the deletion of previously stored data, storing the data item and reporting deletion of the previously stored data and storage of the data item to the tracker.

20. A method as claimed in claim 16, wherein if sufficient storage capacity is not available to store the data item, selecting previously stored data that may be deleted, sending a message to a tracker requesting permission to delete the selected data and receiving a response from the tracker.

21. A method as claimed in claim 20, wherein if the response from the tracker grants permission, deleting the previously stored data, storing the data item and reporting storage of the data item to the tracker.

22. A method as claimed in claim 20, wherein if the response from the tracker refuses permission, determining if the response identifies alternative previously stored data that can be deleted.

23. A method as claimed in claim 20, wherein if the response from the tracker does identify alternative previously stored data, deleting the alternative previously stored data, storing the data item and reporting storage of the data item to the tracker.

24. A method as claimed in claim 22, wherein if the response from the tracker does not identify alternative previously stored data, selecting alternative previously stored data that may be deleted, and sending a message to the tracker requesting permission to delete the alternative previously stored data.

25. A method of operating a tracker in a peer-to-peer network, the method comprising:
receiving, from peers, reports of data stored by the peers;
maintaining a record of the data stored by the peers;
receiving, from peers, requests for permission to delete some selected data;
determining if the selected data can be deleted using the record of stored data; and
sending a response to the requesting peers indicating if permission to delete the selected data is granted or refused.

26. A method as claimed in claim 25, and further comprising:
if it is determined that the selected data can not be deleted, using the record of stored data to identify alternative data that can be deleted, and sending a response to the requesting peers indicating that permission to delete the selected data is refused and identifying the alternative data.

27. A method as claimed in claim 1, wherein the data is video and the peers are clients in a Video on Demand system.

28. An apparatus configured to operate as a peer in a peer-to-peer network, the apparatus comprising:
a memory unit for storing data;
a receiver for receiving a data item from data servers;
a transmitter for sending messages to a tracker;
a receiver for receiving messages from a tracker; and
a processor unit for determining if sufficient memory is available to store a data item, if sufficient memory is available, implementing storage of the data item and generating a message reporting successful storage of the data item to a tracker, if sufficient memory is not available and upon receipt of a message containing instructions from a tracker, implementing deletion of previously stored data in accordance with the instructions, and generating messages reporting deletion of previously stored data to the tracker.

29. An apparatus configured to operate as a tracker in a peer-to-peer network, the apparatus comprising:
a receiver for receiving messages from peers;
a transmitter for sending messages to peers;
a transmitter for sending messages to data servers;
a memory unit for maintaining a record of data stored by the peers; and
a processor unit for determining if the tracker has received a predefined minimum number of messages from peers reporting storage of a data item, if not, selecting previously stored data that may be deleted, generating messages instructing one or more of the peers that do not store the data item to delete the previously stored data and, upon receipt of confirmation of deletion of the previously stored data, generating messages instructing one or more data servers to resend the data item to those peers that have confirmed deletion of the previously stored data.

30. An apparatus configured to operate as a data server in a peer-to-peer network, the apparatus comprising:
a memory unit for storing data;
a processor unit for generating metadata for inclusion with a data item, the metadata at least indicating to peers whether or not they must store the data item; and
a transmitter for sending the data item to one or more peers, the data item including the metadata.

31. An apparatus configured to operate as a peer in a peer-to-peer network, the apparatus comprising:
a memory unit for storing data;
a receiver for receiving a data item from one or more data servers, the data including metadata; and
a processor unit for evaluating the metadata to determine if it is required that the data item be stored at the peer.

32. An apparatus as claimed in claim 31, wherein, if it is intended that the data item be stored, the processor unit determines if sufficient storage capacity is available to store the data item.

33. An apparatus as claimed in claim 32, wherein if sufficient storage capacity is available, the processor unit implements storage of the data item and generates messages reporting storage of the data item to a tracker, and the apparatus further comprises:
a transmitter for sending messages to the tracker.

34. An apparatus as claimed in claim 32, wherein if sufficient memory is not available, the processor unit selects previously stored data that may be deleted, implements deletion of the previously stored data, implements storage of the data item and generates messages reporting deletion of the previously stored data and storage of the data item to a tracker, and the apparatus further comprises:
a transmitter for sending messages to the tracker.

35. An apparatus as claimed in claim 32, wherein if sufficient memory is not available, the processor unit selects previously stored data that may be deleted, and generates messages to a tracker requesting permission to delete the previously stored data, and the apparatus further comprises:
a transmitter for sending messages to a tracker; and
a receiver for receiving messages from the tracker.

36. An apparatus as claimed in claim in 35, wherein if the response from the tracker grants permission, the processor unit implements deletion of the previously stored data, implements storage of the data item and generates messages reporting deletion of the previously stored data and storage of the data item to the tracker.

37. An apparatus as claimed in claim 35, wherein if the response from the tracker does not grant permission, the processor unit determines if the response identifies alternative previously stored data that can be deleted.

38. An apparatus as claimed in claim 37, wherein if the response from the tracker does identify alternative previously stored data, the processor unit implements deletion of the alternative previously stored data, implements storage of the data item and generates messages reporting deletion of the alternative previously stored data and storage of the data item to the tracker.

39. An apparatus as claimed in claim 37, wherein if the response from the tracker does not identify alternative previously stored data, the processor unit selects alternative previously stored data that may be deleted, and generates a message to the tracker requesting permission to delete the alternative previously stored data.

40. An apparatus configured to operate as a tracker in a peer-to-peer network, the apparatus comprising:
a receiver for receiving messages from peers;
a transmitter for sending messages to peers;
a transmitter for sending messages to data servers;
a memory unit for maintaining a record of data stored by the peers; and
a processor unit for, upon receipt of a request for permission to delete some previously stored data from a peer, using the record of stored data to determine if the previously stored data can be deleted, and generating a message to the requesting peers indicating if permission to delete the selected data is granted or refused.

41. An apparatus as claimed in claim 40, wherein, if it is determined that the previously stored data can not be deleted, the processor unit uses the record of stored data to identify alternative previously stored data that can be deleted, and generates a message to the requesting peer indicating that permission to delete the previously stored data is refused and identifying the alternative previously stored data.

42. An apparatus as claimed in claim 28, wherein the data is video and the peers are clients in a Video on Demand system.
